(19) United States
(12) Patent Application Publication
(10) Pub. No.: US 2024/0342663 A1
(43) Pub. Date: Oct. 17, 2024

(54) POROUS MATERIALS, METHODS AND USES THEREOF

(71) Applicant: NATIONAL UNIVERSITY OF SINGAPORE, Singapore (SG)

(72) Inventors: DAN ZHAO, Singapore (SG); Hao YANG, Singapore (SG)

(21) Appl. No.: 18/292,647

(22) PCT Filed: Jul. 27, 2022
(86) PCT No.: PCT/SG2022/050536

§ 371 Date: Jan. 26, 2024

(30) Foreign Application Priority Data
Jul. 28, 2021 (SG) 10202108259V

(51) Int. Cl. B01D 71/02; B01D 61/14; B01D 67/00; B01D 69/02; C01B 32/05

(52) U.S. Cl. CPC B01D 71/021; B01D 67/0067; B01D 69/02; C01B 32/05; B01D 61/145; B01D 2325/022; B01D 2325/025; B01D 2325/02833

(57) ABSTRACT

This disclosure concerns a method of forming a porous material, comprising impregnating a porous polymer with a pore-forming agent in order to form an impregnated polymer, and at least partially carbonising the impregnated polymer at a temperature of about 150° C. to about 500° C. in order to form the porous material. The porous material is characterised by a crystallinity of about 10% to about 70% relative to the porous polymer. This disclosure also concerns the porous material thereof.

### FIELD

The present disclosure relates to porous materials and uses thereof. The present disclosure also relates to methods of forming the presently disclosed porous materials.

### BACKGROUND

In the membrane filtration art, porous materials-based substrates used to support the membrane are equally as important as the membrane itself. In fact, the selection of an appropriate substrate can affect the overall performance of the membrane and hence the filtration. However, conventional substrates fall short when organic solvents are involved because of the severe swelling of the polymeric chains in the substrates.

One commonly used substrate is polyacrylonitrile (PAN) substrate. PAN substrates are used either in flat-sheet or hollow fiber forms in organic solvent nanofiltration and reverse osmosis. To improve its usability, PAN is often blended with other polymers to alter the final pore size distribution, for example, PAN hollow fiber membrane blending with methyl methacrylate. However, such composites are brittle and are not easy to handle in an industrial setting. Commercial PAN substrates also have poor organic solvent resistance, low porosity and low flux for nanofiltration. The blending with other polymeric additives cannot effectively solve these problems.

It would be desirable to overcome or ameliorate at least one of the above-described problems.

### SUMMARY OF INVENTION

The present invention is predicated on the understanding that the tradeoff between the solvent resistance and mechanical strength of the conventional polymeric substrates can be overcome by the interplay of polymers and pore-forming agents. In addition to using the pore-forming agents to control the pore size of the substrates, by carbonising the polymer in the presence of the pore-forming agents at a suitable temperature, the resultant porous substrate can have an improved solvent resistance and acceptable mechanical strength.

The present invention provides a method of forming a porous material, comprising:
a) impregnating a porous polymer with a pore-forming agent in order to form an impregnated polymer; and
b) at least partially carbonising the impregnated polymer at a temperature of about 150° C. to about 500° C. in order to form the porous material;
   wherein the porous material is characterised by a crystallinity of about 10% to about 70% relative to the porous polymer.

The pore-forming agents can be adsorbed into pores and cavities in the solid porous polymer during the impregnation step. During carbonisation, the pore-forming agent within the pores and cavities of the polymer evaporates and escapes from the polymer, and in the process expands the pores of the polymer, and optionally the pore necks. The carbonisation of the impregnated polymer leads to their structural transition from linear polymeric chains into highly cross-linked network structures with low conformational flexibility, thus improves the solvent resistance. The porous material also has a high flux for solvent permeation.

In some embodiments, the pore-forming agent is selected from a metal salt.

In some embodiments, the pore-forming agent is selected from an inorganic metal salt.

In some embodiments, the pore-forming agent is selected from calcium nitrate, calcium nitrite, calcium chloride, magnesium nitrate, magnesium nitrite, magnesium chloride, sodium nitrate, sodium nitrite, sodium carbonate, potassium carbonate, aluminium nitrate, aluminium nitrite, zinc nitrate, ferric nitrate, ferrous nitrate, cupric nitrate, calcium acetate, tetrabutylammonium bromide, sodium pyridine acetate or a combination thereof.

In some embodiments, the pore-forming agent is provided in an aqueous medium at a concentration of about 0.1 M to about 10 M, or preferably about 0.5 M.

In some embodiments, a weight ratio of porous polymer to pore-forming agent is about 0.1 to 0.4.

In some embodiments, the porous polymer is a porous polymer sheet or a hollow fiber.

In some embodiments, the porous polymer is selected from polyacrylonitrile (PAN), polyethersulfone (PES), polyvinylidene fluoride (PVDF), polysulfone, sodium alginate, chitosan, polydimethylsiloxane, polyvinyl alcohol, poly(ether-ether-ketone), poly(methyl methacrylate) (PMMA), polytetrafluoroethylene (PTFE) or a combination thereof.

In some embodiments, the impregnation step is performed for at least about 1 h, or preferably about 24 h.

In some embodiments, the method further comprises a step of drying the impregnated polymer after the impregnation step.

In some embodiments, the impregnated polymer is carbonised at a temperature of about 200° C.

In some embodiments, the carbonisation step is performed with a ramp rate of about 1° C. min⁻¹ to about 10° C. min⁻¹, or preferably about 2° C. min⁻¹.

In some embodiments, the impregnated polymer is carbonised for about 30 min to about 360 min, or preferably about 90 min.

In some embodiments, the impregnated polymer is carbonised in the presence of oxygen.

In some embodiments, the method further comprises a step of washing the porous material with water and/or ethanol.

In some embodiments, the porous material is characterised by a degree of carbonisation relative to the porous polymer of at least about 20%.

In some embodiments, the porous material is characterised by an increase in pore size relative to the porous polymer of about 5 times to about 100 times.

The present invention also provides a method of converting a porous polymer into a membrane substrate, comprising:
a) impregnating the porous polymer with a pore-forming agent in order to form an impregnated polymer; and
b) at least partially carbonising the impregnated polymer at a temperature of about 150° C. to about 500° C. in order to form the membrane substrate;
   wherein the membrane substrate is characterised by a crystallinity of about 10% to about 70% relative to the porous polymer.

The present invention also provides a porous material, comprising an at least partially carbonised porous polymer, wherein the porous material has a pore size of about 100 nm to about 800 nm; and wherein the at least partially carbonised porous polymer is characterised by a crystallinity of about 10% to about 70% relative to the uncarbonised porous polymer.

In some embodiments, a degree of carbonisation of the at least partially carbonised porous polymer is characterised by an about 30% to about 90% decrease in X-ray diffraction (XRD) peak intensity relative to the uncarbonised porous polymer.

The porous material of the present invention is an organic porous material. As compared to an inorganic substrate, the organic substrate can show both high solvent resistance and mechanical strength. Besides, these substrates from carbonised polymers have good processability and can be easily scaled-up, which are beneficial for industrial applications. The cost of these polymeric substrates is also cheaper than commonly used inorganic substrates (e.g. ceramic substrates) in industrial.

In some embodiments, the porous material has a pore size of about 100 nm to about 300 nm.

In some embodiments, the at least partially carbonised porous polymer is about 40% to about 70% carbonised.

In some embodiments, the porous material is characterised by a molecular weight cut-off (MWCO) of about 500 kDa to about 4000 kDa, or preferably about 1500 kDa.

In some embodiments, the porous material is characterised by a water permeance of 800 L m⁻² h⁻¹ bar⁻¹ to about 1100 L m⁻² h⁻¹ bar⁻¹.

In some embodiments, the porous material is characterised by a DMF permeance of 1200 L m⁻² h⁻¹ bar⁻¹ to about 1600 L m⁻² h⁻¹ bar⁻¹.

In some embodiments, the porous material is characterised by a n-hexane permeance of 2400 L m⁻² h⁻¹ bar⁻¹ to about 2800 L m⁻² h⁻¹ bar⁻¹.

In some embodiments, the porous material is characterised by a NMP permeance of 100 L m⁻² h⁻¹ bar⁻¹ to about 160 L m⁻² h⁻¹ bar⁻¹.

In some embodiments, the porous material is characterised by a DMSO permeance of 80 L m⁻² h⁻¹ bar⁻¹ to about 160 L m⁻² h⁻¹ bar⁻¹.

In some embodiments, the porous material is characterised by a volume swelling of about 0.1% to about 10%, or preferably about 0.1% to about 3.5%.

In some embodiments, the porous material is characterised by a solvent uptake of about 0.1 to about 10%, or preferably about 0.1 to about 3.5%.

20 In some embodiments, the porous material is stable against organic solvents for at least 60 days.

In some embodiments, the organic solvent is selected from DMF, NMP, DMSO, or a combination thereof.

In some embodiments, the porous material is characterised by a tensile strength of about 10 MPa to about 20 MPa, or preferably about 13 MPa.

In some embodiments, the porous material is characterised by a decrease in tensile strength relative to the uncarbonised porous polymer of about 10% to about 50%, or preferably about 20%.

In some embodiments, the porous material is characterised by a Young's modulus of about 500 MPa to about 900 MPa, or preferably about 640 MPa.

In some embodiments, the porous material is characterised by an increase in Young's modulus relative to the uncarbonised porous polymer of about 50% to about 200%, or preferably about 130%.

In some embodiment, the porous material is formed as a flat sheet or a hollow fiber.

### BRIEF DESCRIPTION OF DRAWINGS

Embodiments of the present invention will now be described, by way of non-limiting example, with reference to the drawings in which:

FIG. 1 shows (a) optical images of the carbonised PAN substrates; (b) cross-sectional and (c) surface FESEM images of the carbonised PAN substrates.

FIG. 2 shows (a) pure solvent permeance as a function of their inverse viscosity for C-PAN substrates, with the dashed line indicating a hypothetical linear relationship; (b) rejection of the C-PAN substrates for polyethylene oxide (PEO) with different molecular weight and (c) rejection as a function of In dₛ.

FIG. 3 shows (a) swelling degree of the C-PAN substrates in six different organic solvents; and (b) long-term solvent permeance of the C-PAN substrates in aggressive organic solvents.

FIG. 4 shows (a) stress-strain curves of the PAN and C-PAN substrates; and (b) Young's modulus and tensile strength of PAN and C-PAN substrates.

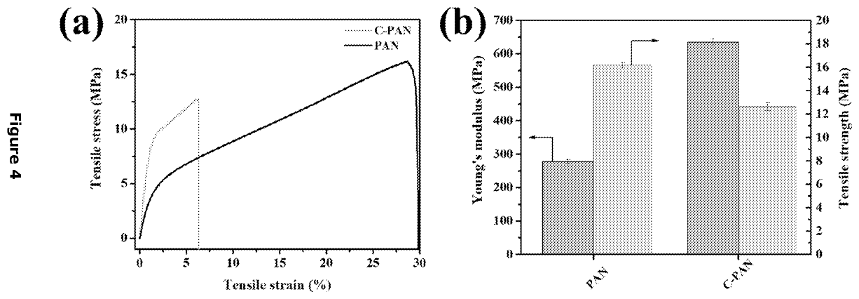

FIG. 5 shows XRD patterns of original non-carbonised PAN and carbonised PAN substrates formed at different temperatures.

### DETAILED DESCRIPTION

The inventors have found that by using the pore-forming agents to control the pore size of the polymer and carbonising the polymer in the presence of the pore-forming agents at a suitable temperature, the resultant porous material can have an improved (or at least acceptable) mechanical strength. These carbonised membrane substrates are suitable for use in permeation of aggressive organic solvents. This allows for the preparation and scale-up of highly permeable and robust porous substrates for industrial liquid separations, especially those involving aggressive organic solvents. The high flux of the porous material can effectively improve productivity in practical applications, such as nanofiltration. The porous material is suitably stable in polar protic solvents, nonpolar aprotic solvents as well as polar aprotic solvents. The swelling degrees of the porous material in aggressive organic solvents are very low, which makes them ideal substrates/separators in practical applications involving organics, such as organic solvent nanofiltration and flow battery. The porous material can have a desirable Young's modulus (for example, about 640 MPa) and tensile strength (for example, about 13 MPa). The high mechanical strength can prevent premature fracture during the long-term operations in industry.

In contrast, earlier studies was carried out at a very high temperature and which resulted in a porous material with poor mechanical properties (e.g. brittle).

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

As used herein, “polyacrylonitrile” or “PAN” is a vinyl polymer, and a derivative of the acrylate family of polymers. It is made from the monomer acrylonitrile and can be polymerised by free radical vinyl polymerization. PAN is a synthetic, semicrystalline organic polymer, with the linear formula (C₃H₃N)ₙ. Though it is thermoplastic, it does not melt under normal conditions. It degrades before melting. More commonly used are PAN copolymers made from mixtures of other monomers with acrylonitrile as the main monomer. For example, monomers of vinyl chloride, styrene and/or butadiene can be added to acrylonitrile to form PAN copolymers. Accordingly, PAN homopolymer and PAN copolymers are within the scope of PAN as used herein to describe the present invention. In particular, PAN homopolymer, having a weight-average molecular weight Mw 30,000 to 250,000; copolymer PAN-methyl acrylate, PAN-methyl methacrylate may be used.

The term “pore-forming agent” as used herein refers to an additive which can be added to the porous polymer in order to alter the polymer's permeation property. In general, the pore-forming agent turns into a fluid with low viscosity when melted at elevated temperatures. In use, the pore-forming agent acts to increase the pore size of the porous polymer due to the volume expansion when it changes its phase during the carbonisation step. For example, the pore-forming agent may decompose at a high temperature to release a volatile gas. The escaping gas may push against the walls of the pores to increase the pore size.

The term “membrane” as used herein refers to a polymeric material which is porous, for use in an application that utilises this property. Such membranes are usually permeable to certain selective entities when subjected to, for example, a pressure and/or concentration gradient. Such membranes can be used in membrane technology, which relies on physical forces (and optionally without heat or at cold conditions) to separating gases or liquids from a mixture. The skilled person would be aware that the selection of polymeric membrane is not trivial and has to have appropriate characteristics for the intended application. For example, in the case of biotechnology applications, the polymeric membrane has to offer a low binding affinity for separated molecules. In the case of waste water treatment, the membrane has to withstand the harsh conditions. In this regard, the polymeric membrane can for example be assessed in terms of its chains rigidity, chain interactions, stereo-regularity, and polarity of its functional groups.

“Carbonisation” refers to the conversion of organic matters into carbon through destructive distillation, a chemical process in which decomposition of organic material is achieved by heating it to a high temperature. Carbonisation is a pyrolytic reaction, and is a complex process in which many reactions take place concurrently such as dehydrogenation, condensation, hydrogen transfer and isomerization.

The present invention provides a method of forming a porous material, comprising:
a) impregnating a porous polymer with a pore-forming agent in order to form an impregnated polymer; and
b) at least partially carbonising the impregnated polymer at a temperature of about 150° C. to about 500° C. in order to form the porous material;
   wherein the porous material is characterised by a crystallinity of about 10% to about 70% relative to the porous polymer.

The pore-forming agents can be adsorbed into pores and cavities in the solid porous polymer during the impregnation step. During partial carbonisation, the pore-forming agent within the pores and cavities of the polymer evaporates and escapes from the polymer, and in the process expands the pores of the polymer, and optionally the pore necks. The carbonisation process is stopped before completion to retain some mechanical strength of the original porous polymer and prevent the material from becoming too brittle. The carbonisation process also improves the solvent resistance. The porous material also has a high flux for solvent permeation.

The impregnation step allows the pore-forming agent to enter the pores of the porous polymer. The initial pore size of the porous polymer can be about 10 nm to about 50 nm, or about 10 nm to about 30 nm. The porous polymer can for example be formed using electrospinning techniques, or via extrusion techniques to form a flat sheet or hollow fiber.

In some embodiments, the pore-forming agent is selected from a metal salt. In some embodiments, the pore-forming agent is selected from an inorganic metal salt. The interaction between the cation and the anion determines the stability at high temperature and its suitability for use as a pore forming agent. The metal salt should ideally be stable up to the carbonation temperature and then decompose to generate gas for expanding the pore size. The pore-forming agent is preferentially highly absorbed into the pores of the polymer. Additionally, after the carbonisation step, the residue salts can be easily washed out from the porous material. In some embodiments, the pore-forming agent is selected from calcium nitrate, calcium nitrite, calcium chloride, magnesium nitrate, magnesium nitrite, magnesium chloride, sodium nitrate, sodium nitrite, sodium carbonate, potassium carbonate, aluminium nitrate, aluminium nitrite, zinc nitrate, ferric nitrate, ferrous nitrate, cupric nitrate, calcium acetate, tetrabutylammonium bromide, sodium pyridine acetate or a combination thereof. In some embodiments, the pore-forming agent is selected from calcium nitrate, calcium nitrite, calcium chloride, magnesium nitrate, magnesium nitrite, magnesium chloride, sodium nitrate, sodium nitrite, sodium carbonate, potassium carbonate, aluminium nitrate, aluminium nitrite or a combination thereof.

In other embodiments, the pore-forming agent is an organic salt. For example, calcium acetate, tetrabutylammonium bromide, sodium pyridine acetate or a combination thereof can be used.

In some embodiments, the pore-forming agent is provided in an aqueous medium at a concentration of about 0.1 M to about 10 M. In other embodiments, the concentration is about 0.1 M to about 9 M, about 0.1 M to about 8 M, about 0.1 M to about 7 M, about 0.1 M to about 6 M, about 0.1 M to about 5 M, about 0.1 M to about 4 M, about 0.1 M to about 3 M, about 0.1 M to about 2 M, or about 0.1 M to about 1 M. In some embodiments, the pore-forming agent is provided in an aqueous medium at a concentration of about 0.5 M.

In some embodiments, a weight ratio of porous polymer to pore-forming agent is about 0.1 to about 0.4. In other embodiments, the weight ratio is about 0.1 to about 0.3 or 0.1 to about 0.2.

In some embodiments, the porous polymer is a porous polymer sheet. The porous polymer sheet can be a film or a layer of polymer. In other embodiments, the porous polymer is a hollow fiber. The skilled person would understand that ‘hollow fiber’ refers to a tube like structure. In this regard, the porous material is a membrane substrate.

In some embodiments, the porous polymer is selected from polyacrylonitrile (PAN), polyethersulfone (PES), polyvinylidene fluoride (PVDF), polysulfone, sodium alginate, chitosan, polydimethylsiloxane, polyvinyl alcohol, poly(ether-ether-ketone), poly(methyl methacrylate) (PMMA), polytetrafluoroethylene (PTFE) or a combination or co-polymer thereof.

In an embodiment, when the porous polymer is a PAN, the PAN polymer is a PAN homopolymer. The PAN polymer can have a weight-average molecular weight (Mw) of about 200,000 g mol⁻¹. In another embodiment, the PAN polymer is selected from a PAN homopolymer having a weight-average molecular weight (Mw) of about 30,000 to about 250,000 g mol⁻¹, copolymer PAN-methyl acrylate, PAN-methyl methacrylate and a combination thereof. In another embodiment, the PAN polymer is selected from a PAN homopolymer having a weight-average molecular weight Mw of about 30,000 to about 250,000 g mol⁻¹, copolymer PAN-methyl acrylate and PAN-methyl methacrylate.

In some embodiments, the porous polymer comprises a polymer additive. The polymer additive is a substance that is added to a polymer to modify its properties. Such substance is usually added at a lower weight percentage than the polymer itself, and can be any kind or molecular, polymeric, inorganic or organic substance. For example, plasticizers can be used to lower the glass transition temperature of the polymer, fillers can be used to make it cheaper, and oily components can be used to improve its rheology. Polymer additives can also be added to the porous polymer to adjust the microstructure and pore size of the polymer. Examples of polymer additives are plasticizers (to improve rheology as well as elasticity), anti-aging stabilizers or anti-oxidants (to reduce brittleness, discoloration, and loss of some physical properties), blowing agents (to form a cellular structure within the polymer and reduces density and improves insulation properties), flame retardants (to prevent, delay, or slow down combustion), nucleating agents (to improve mechanical properties, transparency, speed up plastic crystallization rate, reducing overall cycle time), processing additives (to improve the processability and processing characteristics of the polymer), anti-static additives (to minimize the potential for static electricity build up on the surface of the plastic), colorants, odour agent and anti-microbial agent.

An example of a plasticiser is phthalate esters. Examples of anti-oxidants are phenols, aryl amines, and phosphates. Examples of UV stabilizers include benzophenones and benzotriazoles, and carbon black. Examples of flame retardants are halogens such as bromines, phosphorus and nitrogen compounds. Examples of processing additives include lubricants, fatty acids, hydrocarbon waxes, and polyethylene. Examples of anti-static additives include amines, ammonium compounds, and polyethylene glycol esters.

In an embodiment, the polymer additive is selected from polyvinylpyrrolidone (PVP), polyethylene oxide (PEO) and polyvinyl alcohol (PVA).

In an embodiment, the porous polymer comprises a polymer additive at about 5 wt % to about 30 wt % relative to the porous polymer. In another embodiment, the polymer additive is about 10 wt % to about 30 wt %; about 10 wt % to about 25 wt %; about 14 wt % to about 25 wt %; about 14 wt % to about 20 wt %; or about 15 wt % to about 20 wt %. In another embodiment, the polymer additive is about 12 wt %; about 13 wt %; about 14 wt %; about 15 wt %; about 16 wt %; about 17 wt %; about 18 wt %; about 19 wt %; about 20 wt %; about 21 wt %; about 22 wt %; or about 23 wt %.

In some embodiments, the impregnation step is performed for at least about 1 h. In other embodiments, the duration is at least about 2 h, about 3 h, about 4 h, about 5 h, about 6 h, about 8 h, about 10 h, about 12 h, about 24 h, about 48 h.

In some embodiments, the impregnation step is performed for about 24 h.

In some embodiments, the method further comprises a step of drying the impregnated polymer after the impregnation step. The impregnated polymer can be dried by placing it in an oven at about 40° C. to about 90° C., or subjecting the impregnated polymer to a vacuum. Alternatively, the impregnated polymer can be freeze dried.

In some embodiments, the porous material is characterised by a crystallinity of about 10% to about 70% relative to the porous polymer. In this regard, the porous material has less crystallinity than the original porous polymer. In other embodiments, the crystallinity is about 20% to about 70%, about 30% to about 70%, about 30% to about 60%, or about 40% to about 60%.

In some embodiments, the impregnated polymer and/or the porous polymer is at least about 20% carbonised. The degree of carbonisation can be monitored using, for example, X-ray diffraction (XRD) by observing the change in peak intensity. For example, when the polymer is PAN, the degree of carbonisation can be monitored by tracking the loss of intensity for a given peak. In other embodiments, the degree of carbonisation is at least about 30%, about 40%, about 50%, about 60%, about 70%, about 80%, or about 90%.

In some embodiments, the porous material is characterised by a degree of carbonisation relative to the porous polymer of at least about 20%, about 30%, about 40%, about 50%, about 60%, about 70%, about 80%, or about 90%.

In some embodiments, the carbonisation step is performed at a temperature of about 150° C. to about 500° C. In other embodiments, the temperature is about 150° C. to about 450° C., about 150° C. to about 400° C., about 150° C. to about 350° C., about 150° C. to about 300° C., about 150° C. to about 250° C., or about 200° C. to about 500° C.

In some embodiments, the impregnated polymer is carbonised at a temperature of about 200° C., or about 210° C.

In some embodiments, the carbonisation step is performed with a ramp rate of about 1° C. min⁻¹ to about 10° C. min⁻¹. In other embodiments, the ramp rate is about 1° C. min⁻¹ to about 9° C. min⁻¹, about 1° C. min⁻¹ to about 8° C. min⁻¹, about 1° C. min⁻¹ to about 7° C. min⁻¹, about 1° C. min⁻¹ to about 6° C. min⁻¹, about 1° C. min⁻¹ to about 5° C. min⁻¹, about 1° C. min⁻¹ to about 4° C. min⁻¹, about 1° C. min⁻¹ to about 3° C. min⁻¹, or about 1° C. min⁻¹ to about 2° C. min⁻¹. In some embodiments, the carbonisation step is performed with a ramp rate of about 2° C. min⁻¹.

In some embodiments, the impregnated polymer is carbonised for about 30 min to about 360 min. In other embodiments, the duration is about 30 min to about 340 min, about 30 min to about 320 min, about 30 min to about 300 min, about 30 min to about 280 min, about 30 min to about 260 min, about 30 min to about 240 min, about 30 min to about 220 min, about 30 min to about 200 min, about 30 min to about 180 min, about 30 min to about 160 min, about 30 min to about 140 min, about 30 min to about 120 min, about 30 min to about 100 min, about 40 min to about 100 min, about 50 min to about 100 min, about 60 min to about 100 min, about 70 min to about 100 min, or about 80 min to about 100 min. In some embodiments, the impregnated polymer is carbonised for about 90 min.

In some embodiments, the impregnated polymer is carbonised in the presence of oxygen. In other embodiments, the impregnated polymer is carbonised in ambient conditions. Ambient conditions refer to conditions relating to the immediate surroundings. This can relate to conditions having a temperature of about 5° C. to about 40° C., a relative humidity of about 10% to about 90%, pressure of about 1 atm and/or oxygen at about 21%. When used in conjunction with a specified temperature range, ambient conditions refer to a relative humidity of about 10% to about 90%, pressure of about 1 atm and/or oxygen at about 21%.

In some embodiments, the method further comprises a step of washing the porous material. In some embodiments, the porous material is washed with water and/or ethanol.

After performing the method as disclosed herein, the initial porosity of the porous polymer is altered. For example, when the method is performed on PAN polymer with a pore size of about 10 nm, the pore size of the final porous material is about 50 nm to about 500 nm, or about 100 nm to about 500 nm. In some embodiments, a change in pore size is an increase of about 5 times to about 100 times. In other embodiments, the change in pore size is an increase of about 10 times to about 90 times, about 10 times to about 80 times, about 10 times to about 70 times, about 10 times to about 60 times, or about 10 times to about 50 times.

Alternatively, the change in the initial porous polymer to the final porous material can be characterised by the change in MWCO. For example, when PAN polymer having a MWCO of about 100,000 is used, the final porous material has a MWCO of about 1,500,000. In some embodiments, a change in MWCO is an increase of about 10 times to about 100 times. In other embodiments, the change in MWCO is an increase of about 20 times to about 100 times, about 30 times to about 100 times, about 40 times to about 100 times, about 50 times to about 100 times, about 60 times to about 100 times, about 60 times to about 90 times, about 60 times to about 80 times, or about 60 times to about 70 times.

In some embodiments, the method of forming a porous material comprises:
a) impregnating a porous polymer with a pore-forming agent in order to form an impregnated polymer; and
b) at least partially carbonising the impregnated polymer in the presence of oxygen and at a temperature of about 150° C. to about 500° C. in order to form the porous material;
   wherein the porous material is characterised by a crystallinity of about 10% to about 70% relative to the porous polymer.

In some embodiments, the method of forming a porous material comprises:
a) impregnating a porous polymer with a pore-forming agent in order to form an impregnated polymer; and
b) at least partially carbonising the impregnated polymer in the presence of oxygen and at a temperature of about 150° C. to about 500° C. in order to form the porous material;
   wherein the porous material is characterised by a crystallinity of about 10% to about 70% relative to the porous polymer;
   wherein the porous material is characterised by a degree of carbonisation relative to the porous polymer of at least about 20%.

In some embodiments, the method of forming a porous material comprises:
a) impregnating a porous polymer with a pore-forming agent in order to form an impregnated polymer; and
b) at least partially carbonising the impregnated polymer in the presence of oxygen and at a temperature of about 150° C. to about 500° C. in order to form the porous material;
   wherein the porous material is characterised by a crystallinity of about 10% to about 70% relative to the porous polymer;
   wherein the porous material is characterised by a degree of carbonisation relative to the porous polymer of at least about 20%;
   wherein the porous material is characterised by an increase in pore size relative to the porous polymer of about 5 times to about 100 times.

In some embodiments, the porous material is a membrane substrate. In other embodiments, the porous material is a separator for flow battery or a package/coating material.

The present invention also provides a method of converting a porous polymer into a membrane substrate, comprising:
a) impregnating the porous polymer with a pore-forming agent in order to form an impregnated polymer; and
b) at least partially carbonising the impregnated polymer at a temperature of about 150° C. to about 500° C. in order to form the membrane substrate;
   wherein the membrane substrate is characterised by a crystallinity of about 10% to about 70% relative to the porous polymer.

In some embodiments, the method of converting a porous polymer into a membrane substrate comprises:
a) impregnating the porous polymer with a pore-forming agent in order to form an impregnated polymer; and
b) at least partially carbonising the impregnated polymer in the presence of oxygen and at a temperature of about 150° C. to about 500° C. in order to form the membrane substrate;
   wherein the membrane substrate is characterised by a crystallinity of about 10% to about 70% relative to the porous polymer.

In some embodiments, the method of converting a porous polymer into a membrane substrate comprises:
a) impregnating the porous polymer with a pore-forming agent in order to form an impregnated polymer; and
b) at least partially carbonising the impregnated polymer in the presence of oxygen and at a temperature of about 150° C. to about 500° C. in order to form the membrane substrate;
   wherein the membrane substrate is characterised by a crystallinity of about 10% to about 70% relative to the porous polymer;
   wherein the membrane substrate is characterised by a degree of carbonisation relative to the porous polymer of at least about 20%;
   wherein the membrane substrate is characterised by an increase in pore size relative to the porous polymer of about 5 times to about 100 times.

In some embodiments, the method of converting a membrane into a membrane substrate, comprises:
a) impregnating a porous polymer membrane with a pore-forming agent in order to form an impregnated polymer; and
b) at least partially carbonising the impregnated polymer at a temperature of about 150° C. to about 500° C. in order to form the membrane substrate;
   wherein the membrane substrate is characterised by a crystallinity of about 10% to about 70% relative to the porous polymer membrane.

In some embodiments, the method of converting a membrane into a membrane substrate, comprises:
a) impregnating a porous polymer membrane with a pore-forming agent in order to form an impregnated polymer; and
b) at least partially carbonising the impregnated polymer in the presence of oxygen and at a temperature of about 150° C. to about 500° C. in order to form the membrane substrate;
   wherein the membrane substrate is characterised by a crystallinity of about 10% to about 70% relative to the porous polymer membrane.

In some embodiments, the method of converting a membrane into a membrane substrate, comprises:
a) impregnating a porous polymer membrane with a pore-forming agent in order to form an impregnated polymer; and
b) at least partially carbonising the impregnated polymer in the presence of oxygen and at a temperature of about 150° C. to about 500° C. in order to form the membrane substrate;
   wherein the membrane substrate is characterised by a crystallinity of about 10% to about 70% relative to the porous polymer membrane;
   wherein the membrane substrate is characterised by a degree of carbonisation relative to the porous polymer membrane of at least about 20%;
   wherein the membrane substrate is characterised by an increase in pore size relative to the porous polymer membrane of about 5 times to about 100 times.

The present invention also provides a porous material, comprising an at least partially carbonised porous polymer, wherein the porous material has a pore size of about 100 nm to about 800 nm; and wherein the at least partially carbonised porous polymer is characterised by a crystallinity of about 10% to about 70% relative to the uncarbonised porous polymer.

The uncarbonised porous polymer refers to the porous polymer in its initial state. In some embodiments, the at least partially carbonised porous polymer is characterised by a degree of carbonisation relative to the uncarbonised porous polymer of at least about 20%, about 30%, about 40%, about 50%, about 60%, about 70%, about 80%, or about 90%. In some embodiments, a degree of carbonisation of the at least partially carbonised porous polymer is characterised by an about 20% to about 90% decrease in X-ray diffraction (XRD) peak intensity relative to the uncarbonised porous polymer.

In some embodiments, the at least partially carbonised porous polymer is characterised by an increase in pore size relative to the uncarbonised porous polymer of about 5 times to about 100 times.

The porous material of the present invention is an organic porous material. As compared to an inorganic substrate, the organic substrate can show both high solvent resistance and mechanical strength. Besides, these substrates from carbonised polymers have good processability and can be easily scaled-up, which are beneficial for industrial applications. The cost of these polymeric substrates is also cheaper than commonly used inorganic substrates (e.g. ceramic substrates) in industrial.

In some embodiments, the porous material has a pore size of about 100 nm to about 800 nm, about 100 nm to about 700 nm, about 100 nm to about 600 nm, about 100 nm to about 500 nm, about 100 nm to about 400 nm, or about 100 nm to about 300 nm.

In some embodiments, the at least partially carbonised porous polymer is about 20% to about 90% carbonised. In other embodiments, the at least partially carbonised porous polymer is about 30% to about 80% carbonised, about 30% to about 70%, about 40% to about 70%, about 40% to about 60%, or about 40% to about 50% carbonised.

The porous material is able to reject organic solvents of various molecular weights (i.e. the solvent is prevented from passing through the substrate in one or both directions).

The porous material is also able to reject large molecules. Such molecules includes, but are not limited to, dyes and PEG. It should be noted that porous material behaves differently in different solvents and accordingly MWCO determined in one solvent need not coincide with that determined in another solvent. Further, the mathematical model used to determine the MWCO in the aqueous system is subject to its own set of assumptions that naturally leads to inaccuracies. Lastly, the shape of the solute molecules may also play a role in affecting its permeability across the porous material. For example, PEG molecules are generally linear molecules and may slip through the membrane pores more easily compared to the more sterically bulky dyes. As such, dye molecules can be more easily rejected than PEG molecules of comparable molecular weights. Regardless, the use of these molecules provide an appropriate estimate of the molecular weight cut-off (MWCO) of the porous material.

As used herein, “dye” is a substance that is soluble in the solvent it is in. It is used to impart colour by absorbing and/or re-emitting light of a certain wavelength. In this sense, coloured dyes absorb light in the visible wavelength and hence is observed as having a specific colour. Fluorescence dye or fluorophore absorbs light energy of a specific wavelength and re-emits light at a longer wavelength, usually in the visible range. Such are included within the scope of this definition.

The molecular weight cut off (MWCO) can be determined using a series of polyethylene oxide (PEO) or PEG dissolved in DI water. MWCO refers to the lowest molecular weight solute or molecule in which at least 80% (or preferably at least 90%) of the solute or molecule is retained by the membrane.

In some embodiments, the porous material is characterised by a molecular weight cut-off (MWCO) of about 500 kDa to about 4000 kDa. In other embodiments, the MWCO is about 500 kDa to about 3500 kDa, about 500 kDa to about 3000 kDa, about 500 kDa to about 2500 kDa, about 500 kDa to about 2000 kDa, or about 1000 kDa to about 2000 kDa. In some embodiments, the porous material is characterised by a molecular weight cut-off (MWCO) of about 1500 kDa.

In some embodiments, the porous material is characterised by a water permeance of 800 L m⁻² h⁻¹ bar⁻¹ to about 1100 L m⁻² h⁻¹ bar⁻¹.

In some embodiments, the porous material is characterised by a DMF permeance of 1200 L m⁻² h⁻¹ bar⁻¹ to about 1600 L m⁻² h⁻¹ bar⁻¹.

In some embodiments, the porous material is characterised by a n-hexane permeance of 2400 L m⁻² h⁻¹ bar⁻¹ to about 2800 L m⁻² h⁻¹ bar⁻¹.

In some embodiments, the porous material is characterised by a NMP permeance of 100 L m⁻² h⁻¹ bar⁻¹ to about 160 L m⁻² h⁻¹ bar⁻¹.

In some embodiments, the porous material is characterised by a DMSO permeance of 80 L m⁻² h⁻¹ bar⁻¹ to about 160 L m⁻² h⁻¹ bar⁻¹.

In some embodiments, the porous material is characterised by a volume swelling of about 0.1% to about 10%. In other embodiments, the volume swelling is about 0.1% to about 9%, about 0.1% to about 8%, about 0.1% to about 7%, about 0.1% to about 6%, about 0.1% to about 5%, or about 0.1% to about 4%. In some embodiments, the membrane substrate is characterised by a volume swelling of about 0.1% to about 3.5%.

In some embodiments, the porous material is characterised by a solvent uptake of about 0.1 to about 10%. In other embodiments, the solvent uptake is about 0.1% to about 9%, about 0.1% to about 8%, about 0.1% to about 7%, about 0.1% to about 6%, about 0.1% to about 5%, or about 0.1% to about 4%. In some embodiments, the porous material is characterised by a solvent uptake of about 0.1 to about 3.5%.

In some embodiment, the porous material is insoluble in solvents such as N-methylpyrrolidone and dimethylformamide. In another embodiment, the porous material is insoluble in solvents such as acetone, ethyl acetate, hexane, tetrahydrofuran, chloroform, and alcohol solvents such as methanol, ethanol, propanol, isopropanol, 2-butanol, n-butanol, isobutanol, tert-butanol, 1-pentanol, 2-pentanol, 3-pentanol, 2-methylbutanol. In another embodiment, the porous material is insoluble in solvents for at least two months.

In some embodiments, the porous material is stable against organic solvents for at least 60 days. In some embodiments, the organic solvent is selected from DMF, NMP, DMSO, or a combination thereof.

In some embodiments, the porous material is characterised by a tensile strength of about 10 MPa to about 20 MPa. In other embodiments, the tensile strength is about 10 MPa to about 19 MPa, about 10 MPa to about 18 MPa, about 10 MPa to about 17 MPa, about 10 MPa to about 16 MPa, about 10 MPa to about 15 MPa, or about 10 MPa to about 14 MPa. In some embodiments, the porous material is characterised by a tensile strength of about 13 MPa.

In some embodiments, the porous material is characterised by a decrease in tensile strength relative to the uncarbonised porous polymer of about 10% to about 50%. In other embodiments, the decrease in tensile strength relative to the uncarbonised porous polymer is about 10% to about 45%, about 10% to about 40%, about 10% to about 35%, about 10% to about 30%, about 10% to about 25%, or about 15% to about 25%.

In some embodiments, the porous material is characterised by a decrease in tensile strength relative to the uncarbonised porous polymer of about 20%.

In some embodiments, the porous material is characterised by a Young's modulus of about 500 MPa to about 900 MPa. In other embodiments, the Young's modulus is about 500 MPa to about 850 MPa, about 500 MPa to about 800 MPa, about 500 MPa to about 750 MPa, about 500 MPa to about 700 MPa, about 500 MPa to about 650 MPa, about 550 MPa to about 650 MPa, or about 600 MPa to about 650 MPa. In some embodiments, the porous material is characterised by a Young's modulus of about 640 MPa.

In some embodiments, the porous material is characterised by an increase in Young's modulus relative to the uncarbonised porous polymer of about 50% to about 200%. In other embodiments, the increase in Young's modulus relative to the uncarbonised porous polymer is about 50% to about 200%, about 60% to about 200%, about 70% to about 200%, about 80% to about 200%, about 90% to about 200%, about 100% to about 200%, about 100% to about 190%, about 100% to about 180%, about 100% to about 170%, about 100% to about 160%, or about 100% to about 150%. In some embodiments, the porous material is characterised by an increase in Young's modulus relative to the uncarbonised porous polymer of about 130%.

In some embodiment, porous material is formed as a flat sheet or a hollow fiber.

### EXAMPLES

### Preparation of Carbonised PAN (C-PAN) Substrates

The C-PAN substrates were prepared by carbonisation of commercial PAN ultrafiltration membranes in a tube furnace. The PAN membranes were first immersed into a 0.5 mol L⁻¹ calcium nitrate aqueous solution for 24 h. After drying at room temperature, the PAN membranes together with a glass substrate were transferred into a tube furnace. The whole carbonisation was conducted under an air atmosphere. The temperature inside the tube furnace was first increased from 30 to 210° C. with a ramp rate of 2° C. min⁻¹. Then the PAN was carbonised under 210° C. for 90 min. After naturally cooling to room temperature, the carbonised PAN substrates were taken out from the tube furnace and then washed with water and ethanol, respectively. The carbonised porous PAN membranes were stored within deionized water before use.

### Test of Solvent Permeance and Molecular Weight Cut-Off (MWCO)

The solvent permeation performance of the prepared C-PAN substrates was evaluated in a dead-end filtration system. Water and common organic solvents were poured into the system with the prepared C-PAN substrates to test their solvent permeance. Before the test, the upstream side of the membrane was first kept at 2 bar for at least 2 h to reach a steady state. Then the permeate was collected and weighed three times at fixed intervals, and the average value of the permeance (J, L m⁻² h⁻¹ bar⁻¹) was obtained. The MWCO of membranes was measured via rejection experiments using polyethylene oxide (PEO) with different molecular weight (Mw=100,000, 300,000, 1,000,000, 2,000,000 and 5,000,000 Da) at a concentration of 50 ppm as feed solutions. The concentrations of permeate and feed solutions were determined by a total organic carbon analyzer.

### Characterisation of C-PAN Substrates

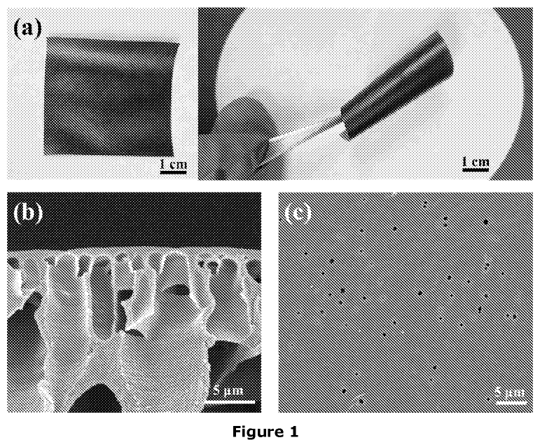

The C-PAN substrates can be prepared by the carbonisation of commercial PAN ultrafiltration membranes with asymmetric pore structures. The C-PAN are flexible and robust and can be easily twisted as shown in FIG. 1a. The asymmetric finger-like pores remained after the carbonisation process as shown in its cross-sectional field-emission scanning electron microscopy (FESEM) image (FIG. 1b). Usually, the surface porosity of the commercial polymeric membranes is very low, resulting in a low flux for solvents. The MWCO of the commercial PAN membranes used is ˜100,000, which corresponds to pore sizes of around 10 nm. Pore-forming agents, i.e. calcium nitrate, are used during the carbonisation process to produce large pores and enhance the porosity of the substrates. The surface FESEM images show that the pores with sizes of 100-500 nm were generated after the carbonisation. Therefore, the carbonised porous PAN membranes are expected to be ideal substrates with superior flux for solvent permeation.

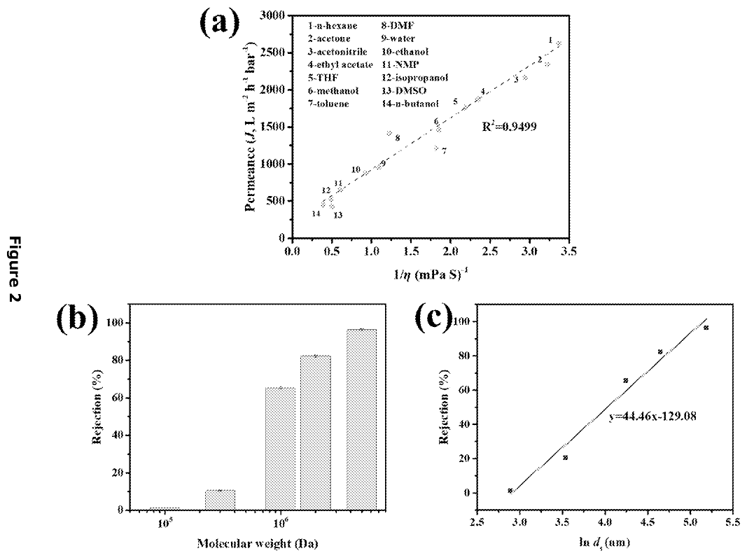

The MWCO of the C-PAN substrates was measured by rejecting PEO with different molecular weight as shown in FIGS. 2b and c. Since rejection is the log normal probability function of the solute size (ds), a straight line can be obtained when plotting a log normal probability curve of the rejection against solute size. The MWCO of the C-PAN was calculated to be 1471.2 kDa.

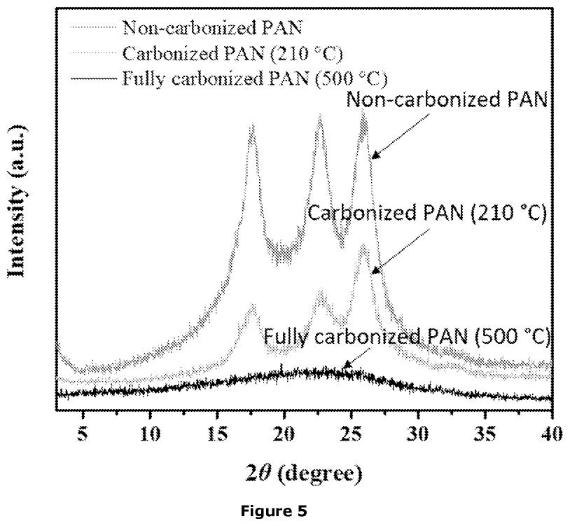

XRD characterization of the substrates where performed. A sample was partially carbonised at 210° C. and another sample was carbonised at 500° C. These samples were compared with the original non-carbonised substrate, As shown in FIG. 5, the carbonised substrates (210° C.) display weaker crystallinity peak intensity than the non-carbonised ones. The fully carbonised substrate shows amorphous structures at high temperature of 500° C.

### Solvent Permeance

Common polar and nonpolar organic solvents, including methanol, ethanol, isopropanol, n-butanol, ethyl acetate, acetone, acetonitrile, toluene, n-hexane, N,N-dimethylformamide (DMF), tetrahydrofuran (THF), N-methyl-2-pyrrolidone (NMP) and dimethyl sulfoxide (DMSO), as well as water were used to test the solvent permeance of the carbonised PAN. Interestingly, the carbonised porous PAN substrates could demonstrate outstanding water permeance of 956 L m⁻² h⁻¹ bar⁻¹, DMF permeance of 1415 L m⁻² h⁻¹ bar⁻¹ and n-hexane permeance of 2620 L m⁻² h⁻¹ bar⁻¹. To explore the molecular transfer mechanism, the relation between permeance (J) and molecular physical parameters is established. In FIG. 2a, the permeance of different solvents as a function of the reciprocal of the viscosity (η) is plotted. The relationship is J=K/η, where K is a proportionality constant. Such equation is identical to that of porous inorganic membranes with hydrophobic and permanent nanopores. Molecular transport is dominated by pore flow model (i.e., Poiseuille's law), which is mainly related to solvent viscosity.

In contrast, the water permeance of the original non-carbonised PAN substrate is 162 L m⁻² h⁻¹ bar⁻¹.

### Solvent Resistance

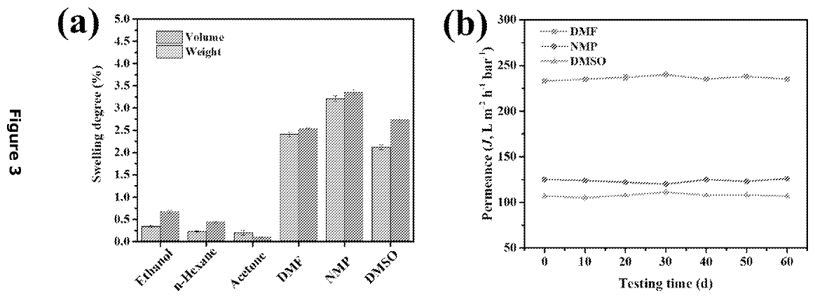

Six different solvents including polar protic solvents (ethanol and acetone), nonpolar aprotic solvents (n-hexane) and polar aprotic solvents (DMF, NMP and DMSO) were used to evaluate the swelling of the C-PAN substrates. The volume swelling and weight swelling degrees of the C-PAN substrates were calculated after 15 days' soaking in organic solvents as shown in FIG. 3a. The C-PAN substrates display excellent solvent resistance in those typical solvents with low volume swelling (from 0.2 to 3.2%) and solvent uptake (from 0.1 to 3.3%). The carbonisation of the PAN substrates leads to their structural transition from linear polymeric chains into highly cross-linked network structures with low conformational flexibility, thus dramatically enhancing the solvent resistance of the PAN substrates. In a long-term test, the C-PAN substrates were soaked in organic solvents for 60 days and they demonstrate excellent stability with aggressive organic solvents including DMF, NMP and DMSO.

In contrast, organic solvent swelling properties of the original non-carbonised PAN substrates cannot be tested since they can be dissolved in the aggressive organic solvents including DMF, NMP and DMSO.

### Mechanical Properties

The mechanical properties of PAN and C-PAN substrates were characterized by the tensile test with a stretching rate of 2 mm min⁻¹. The C-PAN shows a tensile strength of 12.6 MPa and Young's modulus of 634.5 MPa. The tensile strength of the C-PAN was decreased by 21% while Young's modulus was increased by 133% after the carbonisation. It can be concluded that the C-PAN substrates after carbonisation still demonstrate high mechanical properties, which can meet the requirements of the practical applications.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of forming a porous material, comprising:
a) impregnating a porous polymer with a pore-forming agent in order to form an impregnated polymer; and
b) at least partially carbonising the impregnated polymer at a temperature of about 150° C. to about 500° C. in order to form the porous material;
wherein the porous material is characterised by a crystallinity of about 10% to about 70% relative to the porous polymer.

2. (canceled)

3. The method according to claim 1, wherein the pore-forming agent is a metal salt selected from calcium nitrate, calcium nitrite, calcium chloride, magnesium nitrate, magnesium nitrite, magnesium chloride, sodium nitrate, sodium nitrite, sodium carbonate, potassium carbonate, aluminium nitrate, aluminium nitrite, zinc nitrate, ferric nitrate, ferrous nitrate, cupric nitrate, calcium acetate, tetrabutylammonium bromide, sodium pyridine acetate or a combination thereof.

4. The method according to claim 1, wherein the pore-forming agent is provided in an aqueous medium at a concentration of about 0.1 M to about 10 M.

5. The method according to claim 1, wherein a weight ratio of porous polymer to pore-forming agent is about 0.1 to about 0.4.

6. The method according to claim 1, wherein the porous polymer is a porous polymer sheet or a hollow fiber, wherein the porous polymer is selected from polyacrylonitrile (PAN), polyethersulfone (PES), polyvinylidene fluoride (PVDF), polysulfone, sodium alginate, chitosan, polydimethylsiloxane, polyvinyl alcohol, poly(ether-ether-ketone), poly(methyl methacrylate) (PMMA), polytetrafluoroethylene (PTFE) or a combination or co-polymer thereof.

7. (canceled)

8. The method according to claim 1, wherein the impregnation step is performed for at least about 1 h.

9. The method according to claim 1, wherein the method further comprises a step of drying the impregnated polymer after the impregnation step.

10. The method according to claim 1, wherein the impregnated polymer is carbonised at a temperature of about 200° C., performed with a ramp rate of about 1° C. min⁻¹ to about 10° C. min⁻¹, and/or for about 30 min to about 360 min, and/or in the presence of oxygen.

11. (canceled)

12. The method according to any claim 1, wherein the method further comprises a step of washing the porous material.

13. The method according to claim 1, wherein the porous material is characterised by a degree of carbonisation relative to the porous polymer of at least about 20% and/or an increase in pore size relative to the porous polymer of about 5 times to about 100 times.

14. (canceled)

15. (canceled)

16. A porous material, comprising an at least partially carbonised porous polymer, wherein the porous material has a pore size of about 100 nm to about 800 nm; and
wherein the at least partially carbonised porous polymer is characterised by a crystallinity of about 10% to about 70% relative to the uncarbonised porous polymer.

17. The porous material according to claim 16, wherein a degree of carbonisation of the at least partially carbonised porous polymer is characterised by an about 30% to about 90% decrease in X-ray diffraction (XRD) peak intensity relative to the uncarbonised porous polymer.

18. The porous material according to claim 16, wherein the porous material has a pore size of about 100 nm to about 300 nm.

19. The porous material according to claim 16, wherein the porous material is characterised by a molecular weight cut-off (MWCO) of about 500 kDa to about 4000 kDa.

20. The porous material according to claim 16, wherein the porous material is characterised by at least one of the following:
i) a water permeance of 800 L m⁻² h⁻¹ bar⁻¹ to about 1100 L m⁻² h⁻¹ bar⁻¹;
ii) a DMF permeance of 1200 L m⁻² h⁻¹ bar⁻¹ to about 1600 L m⁻² h⁻¹ bar⁻¹;
iii) a n-hexane permeance of 2400 L m⁻² h⁻¹ bar⁻¹ to about 2800 L m 2 h⁻¹ bar⁻¹;
iv) a NMP permeance of 100 L m⁻² h⁻¹ bar⁻¹ to about 160 L m⁻² h⁻¹ bar⁻¹;
v) a DMSO permeance of 80 L m⁻² h⁻¹ bar⁻¹ to about 160 L m⁻² h⁻¹ bar⁻¹.

21. The porous material according to claim 16, wherein the porous material is characterised by a volume swelling of about 0.1% to about 10% and/or a solvent uptake of about 0.1 to about 10%.

22. (canceled)

23. The porous material according to claim 16, wherein the porous material is stable against organic solvents for at least 60 days, wherein the organic solvent is selected from DMF, NMP, DMSO, or a combination thereof.

24. The porous material according to claim 16, wherein the porous material is characterised by a tensile strength of about 10 MPa to about 20 MPa, and/or a decrease in tensile strength relative to the uncarbonised porous polymer of about 10% to about 50%.

25. (canceled)

26. The porous material according to claim 16, wherein the porous material is characterised by a Young's modulus of about 500 MPa to about 900 MPa; and/or an increase in Young's modulus relative to the uncarbonised porous polymer of about 50% to about 200%.

27. (canceled)

28. The porous material according to claim 16, wherein the porous material is formed as a flat sheet or a hollow fiber.
